(19) United States
(12) Patent Application Publication
(10) Pub. No.: US 2026/0003128 A1
(43) Pub. Date: Jan. 1, 2026

(54) OPTICAL DEVICES AND METHODS OF MANUFACTURE

(71) Applicant: Taiwan Semiconductor Manufacturing Co., Ltd., Hsinchu (TW)

(72) Inventors: Chia-Han Tsou, Hsinchu (TW); Yu-Siang Lin, Hsinchu (TW); Ming-Fa Chen, Taichung City (TW)

(21) Appl. No.: 18/918,870

(22) Filed: Oct. 17, 2024

Related U.S. Application Data
(60) Provisional application No. 63/665,330, filed on Jun. 28, 2024.

(51) Int. Cl. G02B 6/34; G02B 5/18

(52) U.S. Cl. CPC G02B 6/34; G02B 5/1847

(57) ABSTRACT

A method of forming an optical device as well as the optical device itself are described herein in which a waveguide is formed over a substrate and a meta-atom material is deposited over the waveguide. Once deposited, the metal-atom material is patterned to form a grating coupler over the waveguide.

### PRIORITY CLAIM AND CROSS-REFERENCE

This application claims the benefit of U.S. Provisional Application No. 63/665,330, filed on Jun. 28, 2024, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

An optical device can provide for the coupling of optical signals from an optical fiber to an optical waveguide for use in optical signaling and processing systems. The efficiency of optical coupling has gradually improved, making the design of tapers relevant to advancing optical signal transmission. However, improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a side cross-sectional view illustrating an interposer used in a method for forming a photonics platform, in accordance with some embodiments.

FIG. 2 illustrates a side cross-sectional view illustrating processing the interposer to provide first optical devices, in accordance with some embodiments.

FIG. 3 illustrates a continuation of the processing to provide first optical devices, in accordance with some embodiments.

FIG. 4 illustrates deposition of a dielectric around the first optical devices, in accordance with some embodiments.

FIGS. 5A-5C illustrate formation of second optical devices including a first grating coupler, in accordance with some embodiments.

FIG. 6 illustrates placement of a first semiconductor device, in accordance with some embodiments.

FIG. 7 illustrates placement of a support substrate, in accordance with some embodiments.

FIG. 8 illustrates formation of backside optical devices, in accordance with some embodiments.

FIG. 9 illustrates a placement of an optical fiber, in accordance with some embodiments.

FIG. 10 illustrates a multiple layer grating coupler, in accordance with some embodiments.

FIGS. 11A-11C illustrate additional configurations for the meta-atom material, in accordance with some embodiments.

FIG. 12 illustrates a multiple zone grating coupler, in accordance with some embodiments.

FIG. 13 illustrates a first optical package without an anti-reflective layer, in accordance with some embodiments.

FIG. 14 illustrates a first optical package without an anti-reflective layer and without a coupling lens, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be illustrated and discussed in which meta-atom materials are utilized in order to form grating couplers for transmission and reception of optical signals into and out of a first optical package. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

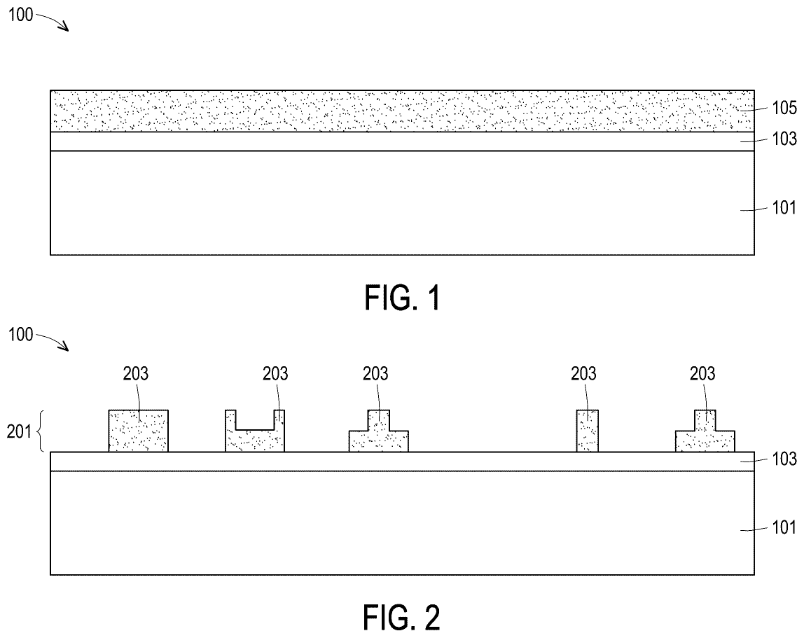

With reference now to FIG. 1, there is illustrated an initial structure of an optical interposer 100. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of the first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment, the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of the first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, the patterning process may be all or at least most of the manufacturing that is used to form these first optical components 203.

FIG. 3 illustrates that, for those components that utilize further manufacturing processes, such as Mach-Zehnder silicon-photonic switches that utilize resistive heating elements, additional processing may be performed either before or after the patterning of the material for the first active layer 201 for forming the first optical components. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

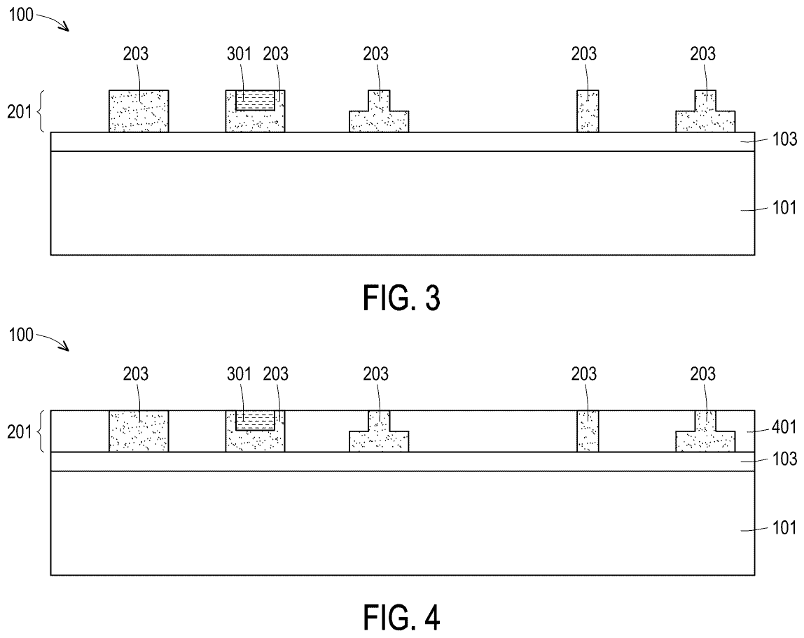

FIG. 4 illustrates that, once the first optical components 203 have been formed, a second insulator layer 401 may be deposited to cover the first optical components 203. The second insulator layer 401 may provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

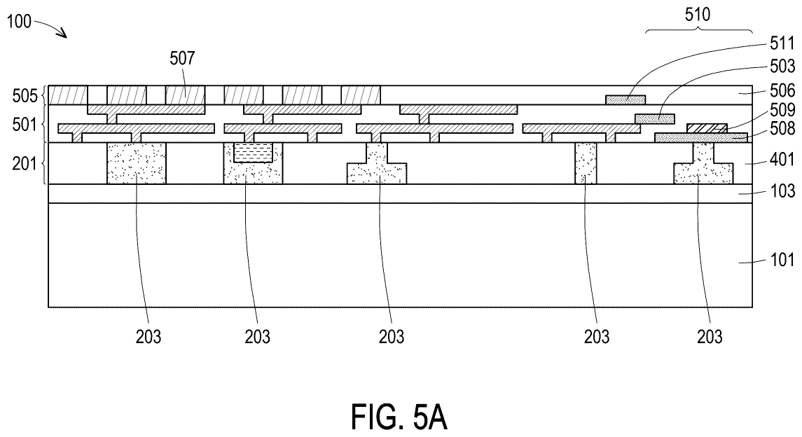

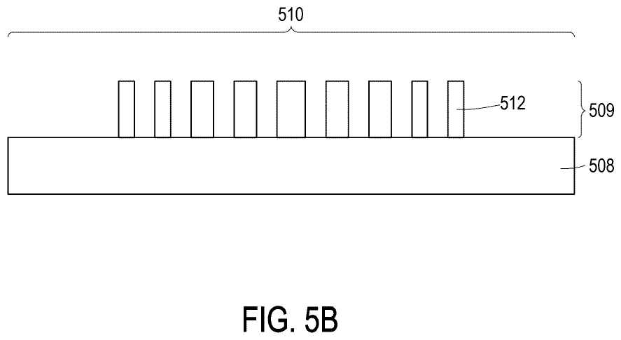

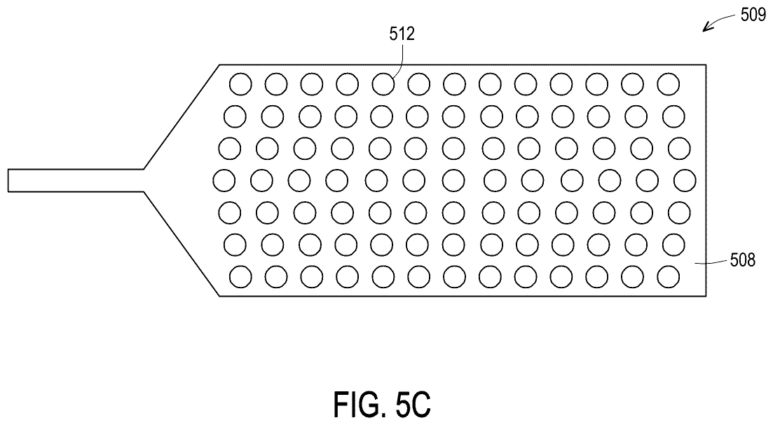

FIG. 5A illustrates that, once the first optical components 203 have been manufactured and the second insulator layer 401 has been formed, one or more second optical components 503 may be formed as part of first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

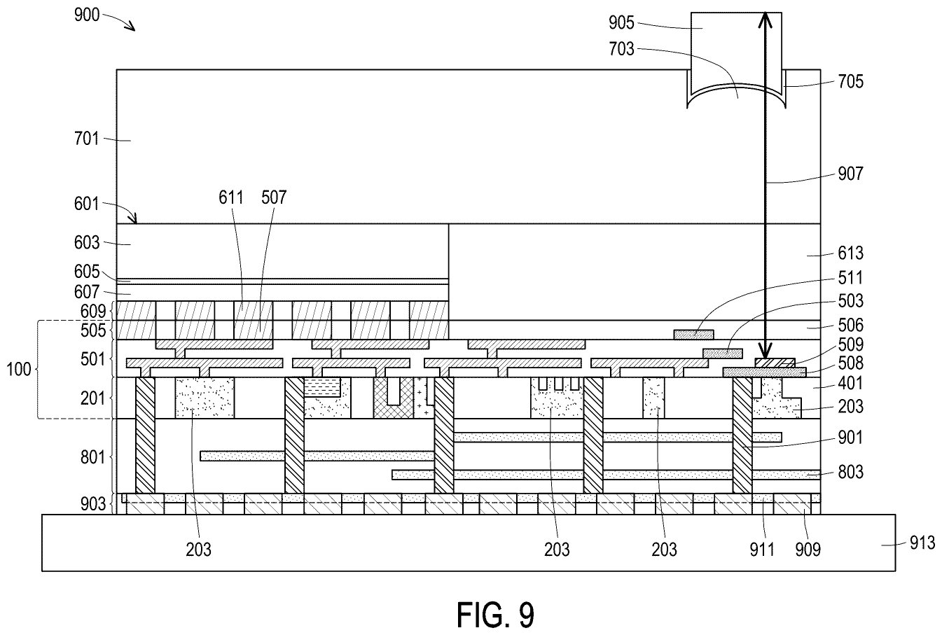

In some embodiments, a portion of the second optical components 503 may be used to provide a waveguide 508 that will underlie a subsequently formed first grating coupler 509 so that the first grating coupler 509 can couple optical signals 907 (not illustrated in FIG. 5A but illustrated and discussed further below with respect to FIG. 9) into and out of the waveguide 508 (and, hence, the rest of the device). The portion of the second optical components 503 that is processed to provide the first grating coupler 509 overlying the waveguide 508 is hereafter referred to as the grating coupler portion 510.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

FIG. 5B additionally illustrates a close up view of the grating coupler portion 510, in which a first grating coupler 509 is formed to be optically coupled with the underlying waveguide 508. In an embodiment the first grating coupler 509 is formed using a meta-atom material 512 in order to not only turn the direction of the optical signals 907 for coupling out of the first optical package 900 but also to help overcome wavelength-restriction shortcomings of other grating couplers. As such, while the precise material is dependent at least in part on the particular wavelength of the optical signals 907 that are being transmitted, in embodiments in which visible light is being utilized (e.g., light with wavelengths between about 400 nm and about 700 nm), the meta-atom material 512 may be a material such as titanium oxide (TiO₂). In other embodiments in which the optical signals 907 being used are for optical communications in the O-band (e.g., light with wavelengths such as 1310 nm and 1550 nm), the meta-atom material 512 may be a material such as amorphous silicon. However, any suitable single material, including even a material similar to the material of the underlying waveguide 508, may be utilized.

In an embodiment the meta-atom material 512 may be deposited into the grating coupler portion 510 using a deposition process such as chemical vapor deposition, physical vapor deposition, atomic layer deposition, combinations of these, or the like. Once deposited, the meta-atom material 512 may be pattered into the desired shape for the first grating coupler 509. In an embodiment the meta-atom material 512 may be patterned using, for example, a photolithographic masking and etching process. However, any suitable deposition and patterning processes may be utilized.

FIG. 5C is a top down view of the first grating coupler 509 over the waveguide 204. In an embodiment the dimensions (e.g., thickness width, length, etc.) of the meta-atom material 512 may be designed with various orientations, shapes, and/or spacings in order to choose a desired local effective refractive index, thereby changing the propagation direction of the optical signals 907. This allows for the design of arbitrary spot sizes and divergence angles of the light output from the first grating coupler 509, allowing the optical signals 907 to be designed to be collimated, convergent, or divergent according to the desired design. In a particular embodiment, and as illustrated in FIG. 5C, the meta-atom material 512 may be shaped into multiple curved rows of circular portions. However, any suitable or desired pattern may be utilized.

In an embodiment the first grating coupler 509 is sized in order to transmit the optical signals 907 into and out of the first grating coupler 509. As such, the precise dimensions of the first grating coupler 509 are based at least in part on the optical signals 907 that will be used. Any suitable dimensions may be utilized.

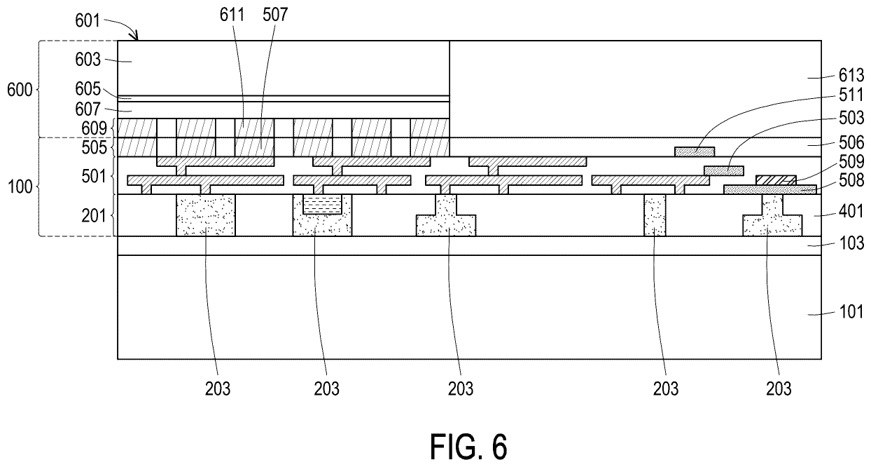

Returning now back to FIG. 5A, once the first grating coupler 509 has been formed, a remainder of the first metallization layer 501 is formed over and around the first grating coupler 509 and the other one or more second optical components 503. In an embodiment the first metallization layers 501 are formed in order to electrically connect the first active layer 201 of first optical components 203 to control circuitry, to each other, and to subsequently attached devices (not illustrated in FIG. 5A but illustrated and described further below with respect to FIG. 6). In an embodiment the first metallization layers 501 are formed of alternating layers of dielectric (deposited to cover the first grating coupler 509 and the one or more second optical components 503) and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, if desired, a pathway (not separately illustrated in FIG. 5A) for the optical signals 907 may be formed through the overlying layers of the first metallization layer 501. In an embodiment, at any desired point in the processes to form the multiple layers of the first metallization layer 501, the materials directly over the first grating coupler 509 may be removed using, e.g., one or more masking and etching processes. Once these materials have been removed, the remaining opening is then filled with a dielectric material suitable for assisting in the transmission of the optical signals 907 into and out of the first grating coupler 509. However, in other embodiments the pathway may be left out.

Once the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 506 such as silicon oxide, silicon nitride, or the like. The first dielectric material 506 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 506 are formed to expose conductive portions of the underlying layers in preparation to form first bond pads 507 within the first bonding layer 505. Once the first openings have been formed within the first dielectric material 506, the first openings may be filled with a seed layer and a plate metal to form the first bond pads 507 within the first dielectric material 506. The seed layer may be blanket deposited over top surfaces of the first dielectric material 506 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 506 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 506, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die 600. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 form a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

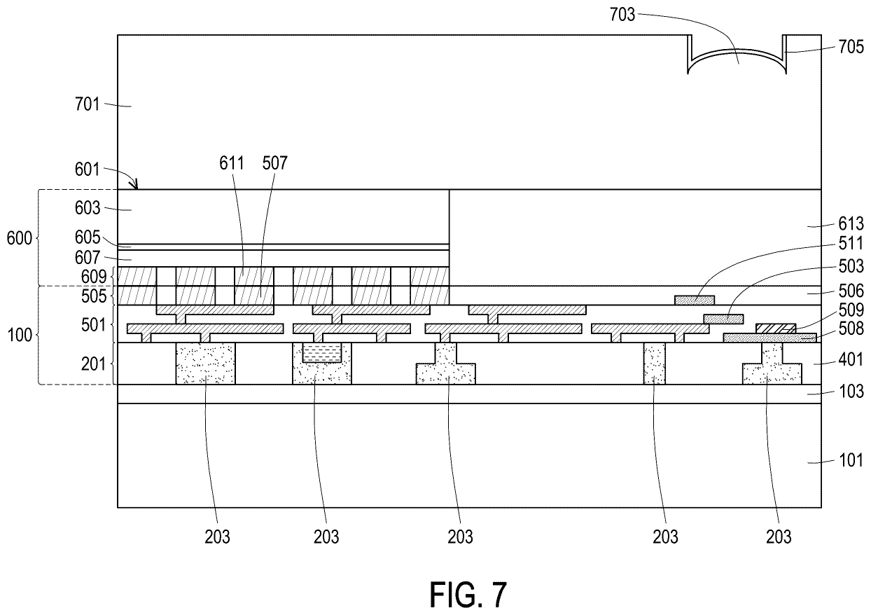

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

FIG. 7 additionally illustrates that the first support substrate 701 comprises a first coupling lens 703 positioned to facilitate movement from an optical fiber 905 (not illustrated in FIG. 7 but illustrated and described further below with respect to FIG. 9). In an embodiment the first coupling lens 703 may be formed by shaping the material of the support substrate (e.g., silicon) using masking and etching processes. However, any suitable process may be utilized.

Additionally, if desired, a first anti-reflective coating (ARC) 705 may be formed on the first coupling lens 703. In an embodiment the first ARC 705 may be one or more layers of materials which help to prevent undesired reflections as light is focused through the first coupling lens 703. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC 705 may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

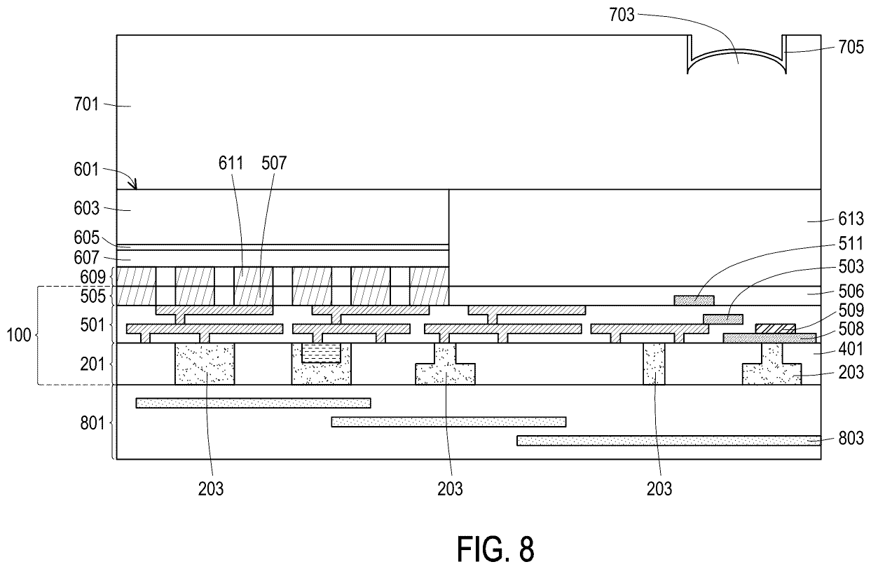

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5A). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 9 illustrates formation of first through device vias (TDVs) 901 and formation of a third bonding layer 903 to form a first optical package 900 which, in some embodiments is an optical engine. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

Optionally, although not shown in FIG. 9, first external connectors may be formed to provide conductive regions for contact between the third bond pads 909 to other external devices. The first external connectors may be conductive bumps (e.g., C4 bumps, ball grid arrays, microbumps, etc.) or conductive pillars utilizing materials such as solder and copper. In an embodiment in which the first external connectors are contact bumps, the first external connectors may comprise a material such as tin, or other suitable materials, such as silver, lead-free tin, or copper. In an embodiment in which the first external connectors are tin solder bumps, the first external connectors may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors is one embodiment which may be used in order to provide connections for the first optical package 900, this is intended to be illustrative and is not intended to limit the embodiments. Rather, any suitable method of physically, electrically, and in some cases optically connecting the first optical package 900, such as dielectric-to-dielectric and metal-to-metal bonding, may also be utilized. Any suitable method of bonding the first optical package 900 may be used.

Once the first external connectors have been formed, the first external connectors may be used in order to attach the first optical package 900 to an interposer substrate 913. In an embodiment the interposer substrate 913 comprises a semiconductor substrate, third metallization layers, second through device vias (TDVs), and second external connectors (all of which are not illustrated for clarity). The semiconductor substrate may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate. The first active devices comprise a wide variety of active devices and passive devices such as capacitors, resistors, inductors and the like that may be used to generate the desired structural and functional requirements of the design for the semiconductor substrate. The first active devices may be formed using any suitable methods either within or else on the semiconductor substrate.

The third metallization layers are formed over the semiconductor substrate of the interposer substrate 913 and the first active devices and are designed to connect the various devices to form functional circuitry. In an embodiment the third metallization layers of the interposer substrate 913 are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, at any desired point in the manufacturing process, the second TDVs may be formed within the semiconductor substrate and, if desired, one or more layers of the third metallization layers, in order to provide electrical connectivity from a front side of the semiconductor substrate to a back side of the semiconductor substrate. In an embodiment the second TDVs may be formed by initially forming through device via (TDV) openings into the semiconductor substrate and, if desired, any of the overlying third metallization layers (e.g., after the desired third metallization layer has been formed but prior to formation of the next overlying third metallization layer). The TDV openings may be formed by applying and developing a suitable photoresist, and removing portions of the underlying materials that are exposed to a desired depth. The TDV openings may be formed so as to extend into the semiconductor substrate to a depth greater than the eventual desired height of the semiconductor substrate.

Once the TDV openings have been formed within the semiconductor substrate and/or any third metallization layers, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate may be thinned until the second TDVs have been exposed. In an embodiment the semiconductor substrate may be thinned using, e.g., a chemical mechanical polishing process, a grinding process, or the like. Further, once exposed, the second TDVs may be recessed using, e.g., one or more etching processes, such as a wet etch process in order to recess the semiconductor substrate so that the second TDVs extend out of the semiconductor substrate.

In an embodiment the second external connectors may be placed and may be, e.g., a ball grid array (BGA) which comprises a eutectic material such as solder, although any suitable materials may be used. Optionally, an underbump metallization or additional metallization layers may be utilized between the third metallization layers and the second external connectors. In an embodiment in which the second external connectors are solder bumps, the second external connectors may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the second external connectors have been formed, a test may be performed to ensure that the structure is suitable for further processing.

Once the interposer substrate 913 has been formed, the first optical package 900 may be attached to the interposer substrate 913. In an embodiment the first optical package 900 may be attached to the interposer substrate 913 by aligning the first external connectors with conductive portions of the interposer substrate 913. Once aligned and in physical contact, the first external connectors are reflowed by raising the temperature of the first external connectors past a eutectic point of the first external connectors, thereby shifting the material of the first external connectors to a liquid phase. Once reflowed, the temperature is reduced in order to shift the material of the first external connectors back to a solid phase, thereby bonding the first optical package 900 to the interposer substrate 913.

Optionally, a first underfill material (not separately illustrated) may be placed. The first underfill material may reduce stress and protect the joints resulting from the reflowing of the first external connectors. The first underfill material may be formed by a capillary flow process after the first optical package 900 has been attached.

FIG. 9 also illustrates placement of an optical fiber 905. In an embodiment the optical fiber 905 may be placed in alignment with the first grating coupler 509 such that optical signals 907 may be transmitted between the optical fiber 905 and the first grating coupler 509. In an embodiment the optical fiber 905 may be aligned using, e.g., a fiber array unit (FAU—not separately illustrated) and may be attached using, e.g., an optical glue.

In operation the optical signals 907 are transmitted between the first grating coupler 509 and the optical fiber 905. In particular, when the optical signals 907 are leaving the first optical package 900, the optical signals 907 travel from the waveguide 508 to the first grating coupler 509 and out to the optical fiber 905. Additionally, when the optical signals 907 are entering the first optical package 900, the optical signals 907 travel from the optical fiber 905 to the first grating coupler 509, and the first grating coupler 509 directs the optical signals 907 into the waveguide 508 and, from there, to the rest of the first optical package 900.

By utilizing the first grating coupler 509 as described above, a high input/output density and broad bandwidth may be achieved while using a material (e.g., the meta-atom material 512) that can be used to design long wavelength regions (>100 nm) while still maintaining a compact size. Additionally, the meta-atom material 512 can be patterned in order to achieve arbitrary spot size and divergence angle of emitting light from the metasurface. As such, the device can satisfy arbitrary requirements of surface coupling and achieve high input/output density and broad bandwidth for wavelength division multiplexing.

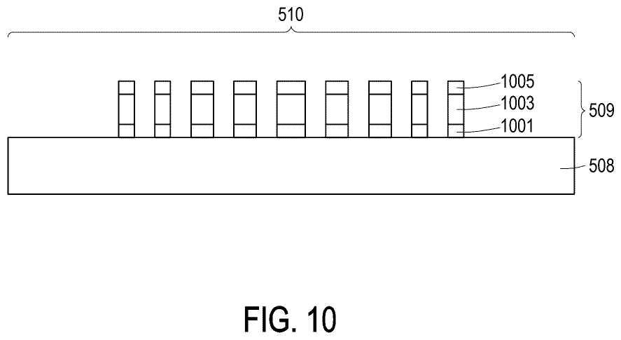

FIG. 10 illustrates another embodiment in which the first grating coupler 509 is a multi-layer structure (instead of a single material as described above with respect to FIG. 5B). In such an embodiment the first grating coupler 509 may be utilized in order to receive and/or transmit optical signals 907 with multiple wavelengths, with each layer working with a different wavelength of the optical signals 907. For example, the first grating coupler 509 may comprise three layers, such as a first layer 1001, a second layer 1003, and a third layer 1005. However, any suitable number of layers may be utilized.

Looking first at the first layer 1001, the first layer 1001 may comprise a material that is suitable to work with the materials in the other layers in order to handle different wavelengths of the optical signals 907. As such, while the precise material to be used is dependent at least in part on the particular wavelengths of the optical signals 907 to be used, in some embodiments the material of the first layer 1001 may be a material such as a metal. However, any suitable materials may be utilized.

The second layer 1003 may be formed over the first layer 1001 and is formed of a different material than the first layer 1001 in order to work with a different wavelength of optical signals 907. As such, while the precise material chosen is dependent at least in part on the precise wavelengths of the optical signals 907, in a particular embodiment the second layer 1003 may comprise a material such as an oxide like silicon oxide or the like. In other embodiments the second layer 1003 may be a semiconductor material such as silicon. However, any suitable material may be utilized.

Finally, the third layer 1005 may be formed over second layer 1003 such that the second layer 1003 is sandwiched between the first layer 1001 and the third layer 1005. In an embodiment the material of the third layer 1005 may be chosen in order to work with the material of the first layer 1001 and the second layer 1003 in order to work with different wavelengths of optical signals 907. As such, while the precise material chosen is dependent at least in part on the precise wavelengths of the optical signals 907, in a particular embodiment the third layer 1005 may comprise a material such as a metal (either the same as or different from the material of the first layer 1001). However, any suitable material may be utilized.

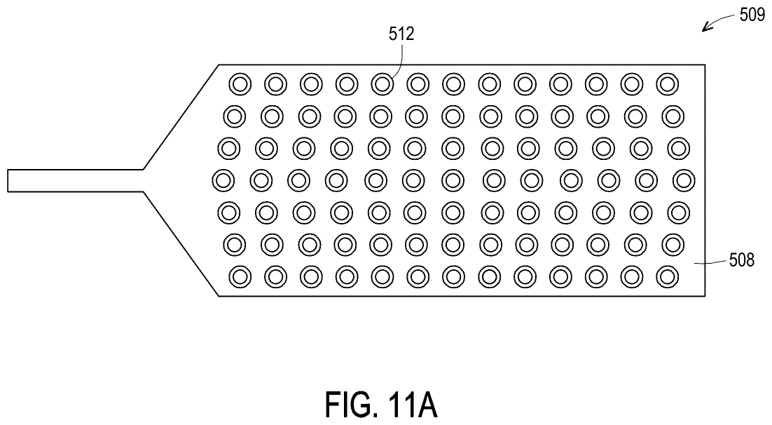

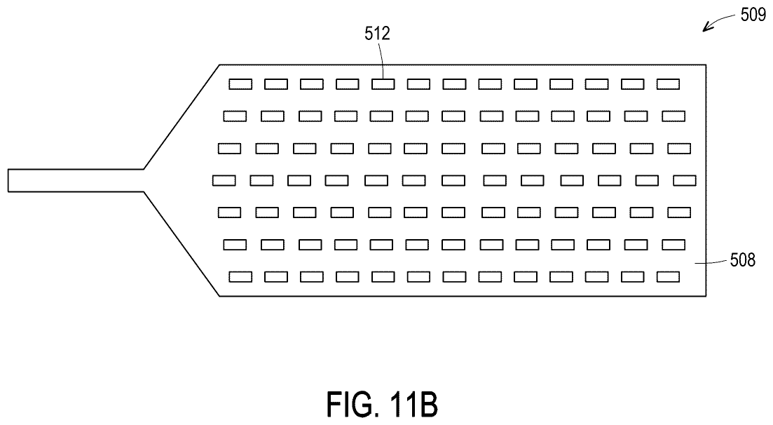

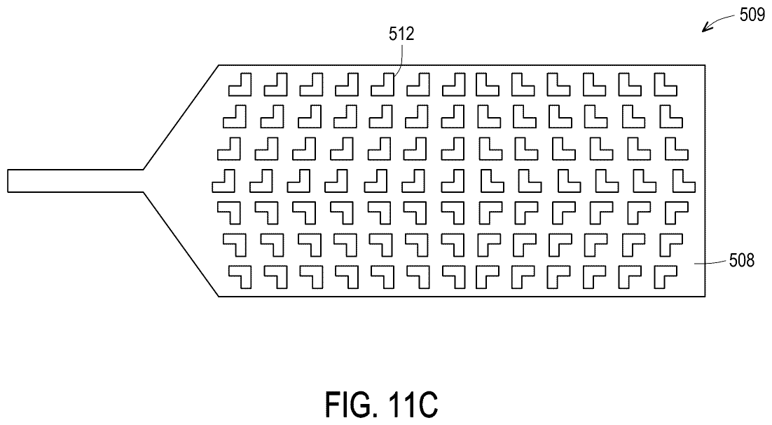

To form the first grating coupler 509 using the multiple layer configuration, the material of each layer (e.g., the first layer 1001, the second layer 1003, and the third layer 1005) may be separately deposited using, e.g., a chemical vapor deposition process, a physical vapor deposition process, an atomic layer deposition process, combinations of these, or the like, to deposit the materials in a stacked configuration. Once each of the individual layers has been deposited, a photolithographic masking and one or more etching process may be used to shape the individual layers into the desired shapes for the first grating coupler 509, such as the shapes described above with respect to FIGS. 5B-5C, or the shapes described further below with respect to FIGS. 11A-11C. However, any suitable methods may be utilized.

FIGS. 11A-11C illustrate top down views of further embodiments for the shape of the meta-atom material 512 in the first grating coupler 509. FIG. 11A illustrates an embodiment in which the meta-atom material 512 is shaped as a cylinder, while in FIG. 11B the meta-atom material 512 is shaped as rectangles. Finally, FIG. 11C illustrates yet another embodiment in which the meta-atom material 512 is patterned into an “L” shape. However, any suitable shapes, including crosses, hearts, triangles, combinations of these, or the like, may be used, and all such shapes and combinations of shapes are fully intended to be included within the scope of the embodiments.

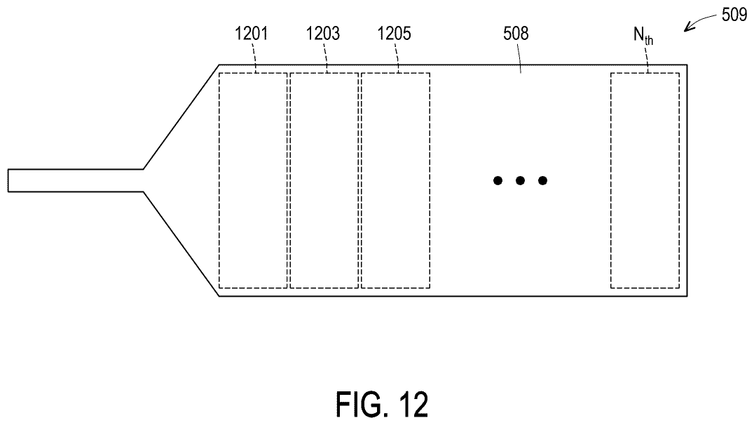

FIG. 12 illustrates a top down view of an embodiment of the first grating coupler 509 in which the first grating coupler 509 comprises different zones with different characteristics in order to handle different wavelengths of light differently. In a particular embodiment the first grating coupler 509 may comprise N number of different zones, such as a first zone 1201, a second zone 1203, a third zone 1205, intermediate zones (represented by the dashed line in FIG. 12) and an end N^{th} zone 1207. In an embodiment the meta-atom material 512 located within each zone is independently designed from the other zones in order to best handle the incoming and outgoing optical signals 907.

For example, in an embodiment the meta-atom materials 512 located within the first zone 1201 is manufactured differently from the meta-atom materials 512 located within the second zone 1203. In a particular embodiment, the meta-atom material 512 located within the first zone 1201 may have different dimensions, different shapes, different materials, different spacings, different combinations of these, or the like. As such, the first zone 1201 and the second zone 1203 can be used to output/input optical signals 907 of different wavelengths so that the first grating coupler 509 can be used with different wavelengths, and multiple grating couplers are not needed.

Similarly, the meta-atom material 512 located within the third zone 1205 and the N^{th} zone 1207 may be manufactured differently from the meta-atom materials 512 located within the first zone 1201 and the second zone 1203. Each zone may independently comprise meta-atom materials 512 with characteristics that are different from the meta-atom materials 512 in adjacent zones. As such, each different region can be independently designed and/or used for different wavelengths of the optical signals 907.

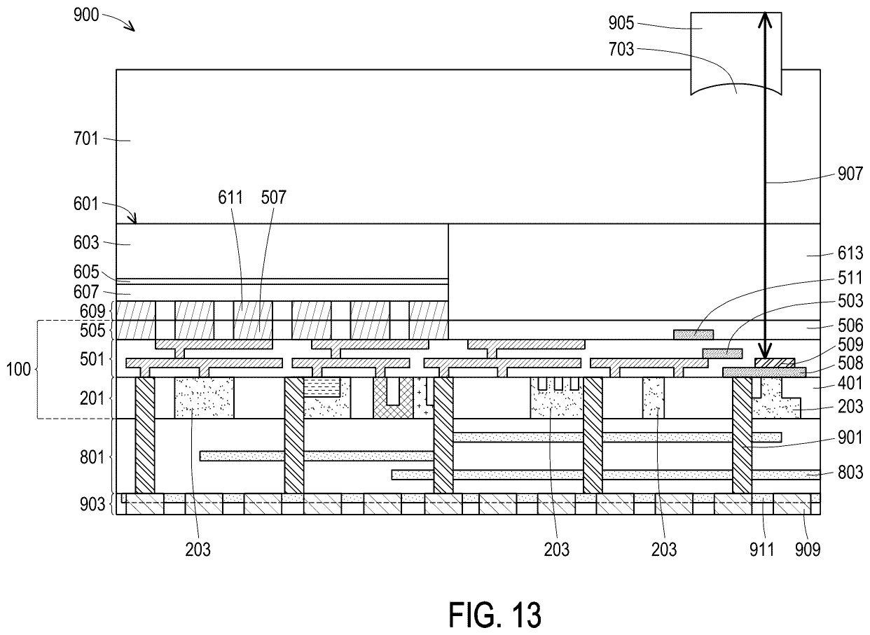

FIG. 13 illustrates another embodiment in which the first ARC 705 is not utilized. In particular, by forming the first grating coupler 509 as discussed herein, the first ARC 705 may not be required. As such, the first ARC 705 may be omitted entirely.

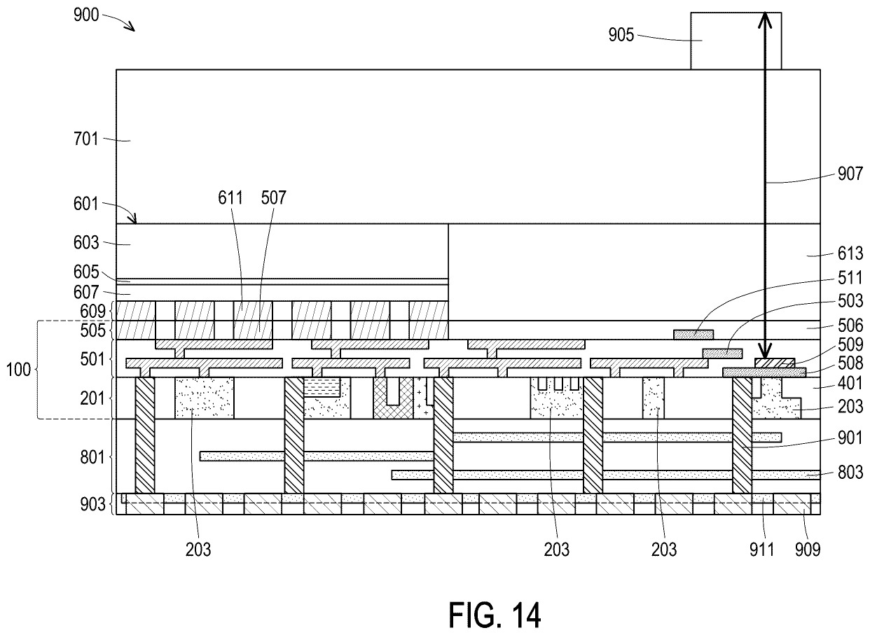

FIG. 14 illustrates yet another embodiment in which both the first ARC 705 and the first coupling lens 703 are not utilized. In particular, by forming the first grating coupler 509 as discussed herein, not only may the first ARC 705 not be required, but the first coupling lens 703 itself may not be required. As such, in some embodiments the first coupling lens 703 may be omitted along with the first ARC 705.

By utilizing the first grating coupler 509 as described above, a high input/output density and broad bandwidth may be achieved. Additionally, by using the meta-atom materials 512, the first grating coupler 509 can be used to design long wavelength regions (>100 nm) while still maintaining a compact size. Finally, the meta-atom material 512 can be used to achieve arbitrary spot size and divergence angle of emitting light from the metasurface. As such, the device can satisfy arbitrary requirements of surface coupling and achieve high input/output density and broad bandwidth for wavelength division multiplexing.

In some embodiments, a method of forming an optical device includes: forming a waveguide over a substrate; depositing a meta-atom material over the waveguide; and patterning the meta-atom material into a grating coupler. In an embodiment the meta-atom material comprises titanium oxide. In an embodiment the depositing the meta-atom material comprises depositing multiple layers. In an embodiment the multiple layers comprises at least one metal and at least one oxide. In an embodiment the multiple layers comprises at least one metal and at least one semiconductor material. In an embodiment the patterning forms circular shapes. In an embodiment the grating coupler comprises multiple zones, each zone having meta-atom material with a different characteristic.

In another embodiment, a method of forming an optical device includes: forming first optical components, the first optical components comprising a first waveguide; forming a grating coupler over the first waveguide, the grating coupler comprising a meta-atom material; forming a bonding layer over the grating coupler; and bonding a semiconductor device to the bonding layer. In an embodiment the meta-atom material comprises titanium oxide. In an embodiment the meta-atom material comprises amorphous silicon. In an embodiment the grating coupler comprises at least three layers of materials. In an embodiment the at least three layers of materials comprises a first layer of metal, a second layer of an oxide, and a third layer of a metal. In an embodiment the meta-atom material within the grating coupler has an “L” shape. In an embodiment the meta-atom material within the grating coupler has a cylindrical shape.

In another embodiment, an optical device includes: a waveguide; and a grating coupler located over the waveguide, the grating coupler comprising a meta-atom material. In an embodiment the meta-atom material comprises titanium oxide. In an embodiment the meta-atom material comprises amorphous silicon. In an embodiment the meta-atom material has a circular shape. In an embodiment the meta-atom material has an “L”-shape. In an embodiment the grating coupler comprises multiple layers.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without de parting from the spirit and scope of the present disclosure.

What is claimed is:

1. A method of forming an optical device, the method comprising:
forming a waveguide over a substrate;
depositing a meta-atom material over the waveguide; and
patterning the meta-atom material into a grating coupler.

2. The method of claim 1, wherein the meta-atom material comprises titanium oxide.

3. The method of claim 1, wherein the depositing the meta-atom material comprises depositing multiple layers.

4. The method of claim 3, wherein the multiple layers comprises at least one metal and at least one oxide.

5. The method of claim 3, wherein the multiple layers comprises at least one metal and at least one semiconductor material.

6. The method of claim 1, wherein the patterning forms circular shapes.

7. The method of claim 1, wherein the grating coupler comprises multiple zones, each zone having meta-atom material with a different characteristic.

8. A method of forming an optical device, the method comprising:
forming first optical components, the first optical components comprising a first waveguide;
forming a grating coupler over the first waveguide, the grating coupler comprising a meta-atom material;
forming a bonding layer over the grating coupler; and
bonding a semiconductor device to the bonding layer.

9. The method of claim 8, wherein the meta-atom material comprises titanium oxide.

10. The method of claim 8, wherein the meta-atom material comprises amorphous silicon.

11. The method of claim 8, wherein the grating coupler comprises at least three layers of materials.

12. The method of claim 11, wherein the at least three layers of materials comprises a first layer of metal, a second layer of an oxide, and a third layer of a metal.

13. The method of claim 8, wherein the meta-atom material within the grating coupler has an “L” shape.

14. The method of claim 8, wherein the meta-atom material within the grating coupler has a cylindrical shape.

15. An optical device comprising:
a waveguide; and
a grating coupler located over the waveguide, the grating coupler comprising a meta-atom material.

16. The optical device of claim 15, wherein the meta-atom material comprises titanium oxide.

17. The optical device of claim 15, wherein the meta-atom material comprises amorphous silicon.

18. The optical device of claim 15, wherein the meta-atom material has a circular shape.

19. The optical device of claim 15, wherein the meta-atom material has an “L”-shape.

20. The optical device of claim 15, wherein the grating coupler comprises multiple layers.
